(19) United States
(12) Patent Application Publication
(10) Pub. No.: US 2024/0088441 A1
(43) Pub. Date: Mar. 14, 2024

(54) NON-AQUEOUS ELECTROLYTE RECHARGEABLE BATTERY AND METHOD FOR MANUFACTURING NON-AQUEOUS ELECTROLYTE RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Gaku OGURA, Fukuoka-shi (JP); Katsuya TANAKA, Kosai-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/243,595

(22) Filed: Sep. 7, 2023

(30) Foreign Application Priority Data
Sep. 12, 2022 (JP) 2022-144669

(51) Int. Cl. H01M 10/0567; H01M 10/04; H01M 50/609

(52) U.S. Cl. CPC H01M 10/0567; H01M 10/0431; H01M 10/049; H01M 50/609

(57) ABSTRACT

A non-aqueous electrolyte rechargeable battery includes a positive electrode, a negative electrode, and a non-aqueous electrolyte. The negative electrode has a sodium concentration of greater than 532 ppm and less than 71100 ppm. The non-aqueous electrolyte rechargeable battery includes a LiBOB equivalent. The LiBOB equivalent is lithium bis(oxalato)borate in the non-aqueous electrolyte or a substance formed when the lithium bis(oxalato)borate reacts with another substance. The non-aqueous electrolyte has a hypothetical concentration of the LiBOB equivalent of 0.35 wt % or greater and 0.56 wt % or less when an amount of the LiBOB equivalent is converted into a weight of the lithium bis(oxalato)borate.

### BACKGROUND

### 1. Field

The following description relates to a non-aqueous electrolyte rechargeable battery and a method for manufacturing a non-aqueous electrolyte rechargeable battery.

### 2. Description of Related Art

Japanese Laid-Open Patent Publication No. 2015-11969 describes a process for manufacturing a non-aqueous electrolyte rechargeable battery. The manufacturing process includes preparing a positive electrode and a negative electrode of a non-aqueous electrolyte rechargeable battery and removing sodium from the prepared electrodes. The manufacturing process further includes injecting a non-aqueous electrolyte, to which lithium bis(oxalato)borate is added, into a battery case.

The lithium bis(oxalato)borate forms a coating on the negative electrode. The coating protects the surface of the negative electrode.

The inventors of the present invention have found that when sodium exists in the negative electrode of the non-aqueous electrolyte rechargeable battery, lithium bis(oxalato)borate reacts with the sodium and causes unevenness when forming the coating.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous electrolyte rechargeable battery includes a positive electrode, a negative electrode, and a non-aqueous electrolyte. The negative electrode has a sodium concentration of greater than 532 ppm and less than 71100 ppm. The non-aqueous electrolyte rechargeable battery includes a LiBOB equivalent. The LiBOB equivalent is lithium bis(oxalato)borate in the non-aqueous electrolyte or a substance formed when the lithium bis(oxalato)borate reacts with another substance. The non-aqueous electrolyte has a hypothetical concentration of the LiBOB equivalent of 0.35 wt % or greater and 0.56 wt % or less when an amount of the LiBOB equivalent is converted into a weight of the lithium bis(oxalato)borate.

In another general aspect, a method for manufacturing a non-aqueous electrolyte rechargeable battery including a positive electrode, a negative electrode, and a non-aqueous electrolyte is provided. The method includes obtaining the negative electrode having a sodium concentration that is greater than 532 ppm and less than 71100 ppm, accommodating an electrode body including the positive electrode and the negative electrode in a battery case and injecting the non-aqueous electrolyte into the battery case. The injected non-aqueous electrolyte includes a LiBOB equivalent. The LiBOB equivalent is lithium bis(oxalato)borate or a substance formed by a reaction of the lithium bis(oxalato)borate with another substance. The injected non-aqueous electrolyte has a concentration of the LiBOB equivalent of 0.35 wt % or greater and 0.56 wt % or less when an amount of the LiBOB equivalent is converted into a weight of the lithium bis(oxalato)borate.

Other features and aspects will be apparent from the following detailed description, the drawings, and the claims.

### BRIEF DESCRIPTION OF THE DRAWINGS

FIG. 1 is a perspective view of a lithium-ion rechargeable battery according to the present embodiment.

FIG. 2 is a schematic diagram showing the structure of an electrode body of the lithium-ion rechargeable battery in the embodiment.

FIG. 3 is a flowchart of a process for manufacturing the lithium-ion rechargeable battery in the embodiment.

FIG. 4 is a diagram showing how parameters are selected in the embodiment.

FIG. 5A is a diagram showing how parameters are selected in the embodiment.

FIG. 5B is a diagram showing how parameters are selected in the embodiment.

FIG. 5C is a diagram showing how parameters are selected in the embodiment.

FIG. 5D is a diagram showing how parameters are selected in the embodiment.

FIG. 6 is a graph showing a resistance distribution of the negative electrode sheets in the present embodiment and a comparative example.

FIG. 7 is a graph showing the relationship between the concentration of LiBOB added to a non-aqueous electrolyte and the deterioration rate.

FIG. 8 is a graph showing the relationship between the sodium concentration in the negative electrode sheet and the delamination resistance of the negative electrode sheet.

FIG. 9 is a table showing how parameters are selected in the embodiment.

FIG. 10 is a graph showing how parameters are selected in the embodiment.

FIG. 11 is a graph showing how parameters are selected in the embodiment.

FIG. 12 is a graph showing how parameters are selected in the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A lithium-ion rechargeable battery according to one embodiment will now be described with reference to the drawings.

Lithium-Ion Rechargeable Battery 10

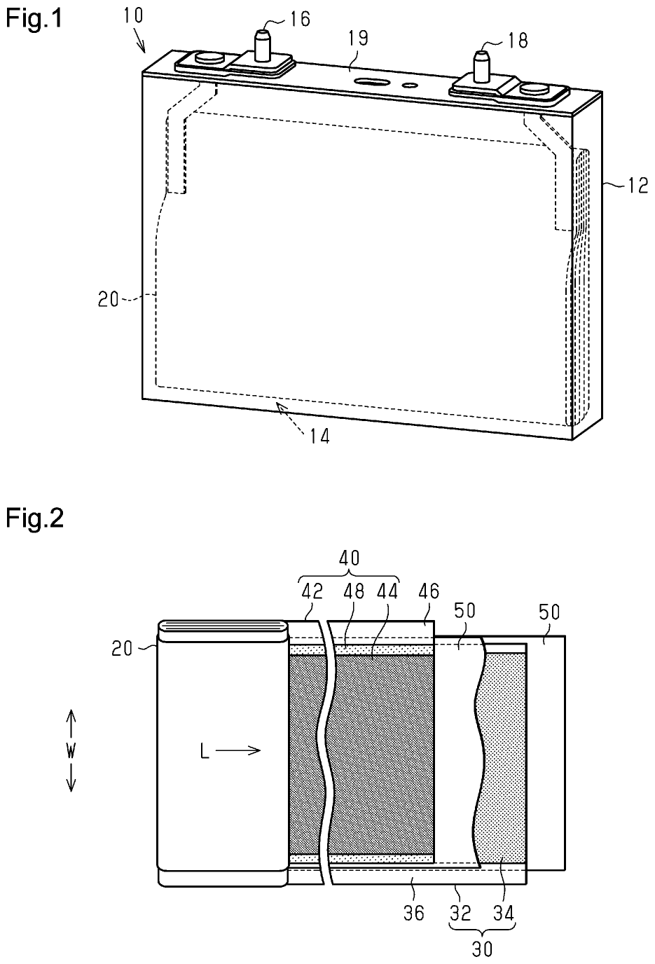

FIG. 1 is a perspective view schematically showing the structure of a lithium-ion rechargeable battery 10 of the present embodiment.

As shown in FIG. 1, the lithium-ion rechargeable battery 10 is configured as a cell battery. The lithium-ion rechargeable battery 10 is connected in series with other lithium-ion rechargeable batteries and installed in a vehicle. The lithium-ion rechargeable battery 10 includes a rectangular parallelepiped battery case 12 having an open upper end. The battery case 12 accommodates an electrode body 20. The battery case 12 is filled with a non-aqueous electrolyte 14 injected through a liquid injection hole in a lid 19. The battery case 12 is formed from metal such as an aluminum alloy. The lithium-ion rechargeable battery 10 further includes a positive electrode external terminal 16 and a negative electrode external terminal 18 that are used when charging or discharging power. The positive electrode external terminal 16 and the negative electrode external terminal 18 do not need to be shaped as shown in FIG. 1.

Electrode Body 20

FIG. 2 is a schematic diagram showing the structure of a rolled electrode body 20. The electrode body 20 is formed by rolling a negative electrode sheet 30, a positive electrode sheet 40, and separators 50 arranged between the sheets into a flattened form. The negative electrode sheet 30 includes a negative electrode current collector 32, serving as a base material, and a negative electrode mixture material layer 34 formed on the negative electrode current collector 32. The negative electrode mixture material layer 34 is not formed on one end of the negative electrode sheet 30 in a direction W that is orthogonal to a rolling direction L. The region that does not include the negative electrode mixture material layer 34 forms a negative electrode connection portion 36 where the negative electrode current collector 32 is exposed.

The positive electrode sheet 40 includes a positive electrode current collector 42, serving as a base material, and a positive electrode mixture material layer 44 formed on the positive electrode current collector 42. As shown in FIG. 2, the end of the positive electrode current collector 42 at the side opposite to negative electrode connection portion 36 in the direction W forms a positive electrode connection portion 46. The positive electrode connection portion 46 is a region in the positive electrode sheet 40 where the positive electrode mixture material layer 44 is not formed. In other words, the positive electrode connection portion 46 is a region where the metal of the positive electrode current collector 42 is exposed.

In the present embodiment, an insulating protective layer 48 is applied to the positive electrode mixture material layer 44 at a position adjacent to the ends of the positive electrode mixture material layer 44 and opposed to the negative electrode mixture material layer 34. The insulating protective layer 48 coats the exposed positive electrode current collector 42.

Manufacturing Process

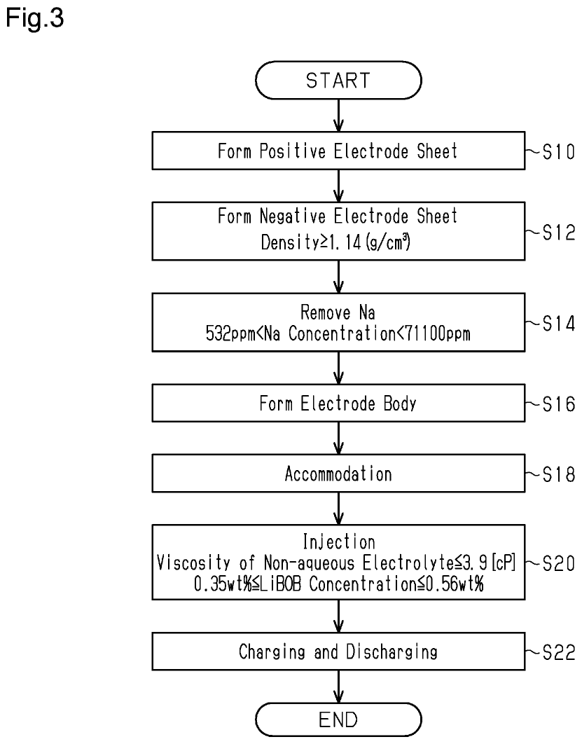

FIG. 3 shows part of a process for manufacturing the lithium-ion rechargeable battery 10.

In a series of steps shown in FIG. 3, first, the positive electrode sheet 40 is formed (S10). In this step, the positive electrode current collector 42 is first formed by a metal foil of, for example, aluminum or alloy of which the main component is aluminum. Next, a positive electrode mixture paste is applied to the positive electrode current collector 42. The positive electrode mixture paste may include a positive electrode active material, a positive electrode solvent, a positive electrode conductive material, and a positive electrode binder. The positive electrode active material may be a lithium-containing mixture metal oxide capable of storing and releasing lithium ions, which are charge carriers in the lithium-ion rechargeable battery 10. Then, the positive electrode mixture paste is dried to form the positive electrode mixture material layer 44 on the positive electrode current collector 42. The positive electrode mixture material layer 44 is formed on each of the two opposing surfaces of the positive electrode current collector 42. The thickness of the positive electrode mixture material layers 44 may be adjusted by applying force to the positive electrode mixture material layers 44 formed on the two surfaces of the positive electrode current collector 42.

Next, the negative electrode sheet 30 is formed (S12). In this step, the negative electrode current collector 32 is first formed by a metal foil of, for example, copper or alloy of which the main component is copper. Next, a negative electrode mixture paste is applied to the negative electrode current collector 32. The negative electrode mixture paste may include a negative electrode active material, a negative electrode solvent, a negative electrode thickener, and a negative electrode binder. The negative electrode active material is a material capable of storing and releasing lithium ions. Examples of the negative electrode active material include a carbon material such as graphite, non-graphitizable carbon, graphitizable carbon, carbon nanotube, and the like. One example of the negative electrode solvent is water. One example of the negative electrode thickener is carboxymethyl cellulose (CMC) that is a thickener including sodium salt. The negative electrode binder may be the same as the positive electrode binder. One example of the negative electrode binder may be styrene-butadiene copolymer (SBR) that is a binder containing sodium salt. Next, the negative electrode mixture paste is dried with a drying device to form the negative electrode mixture material layer 34 on the negative electrode current collector 32. The negative electrode mixture material layer 34 is formed on each of the two opposing surfaces of the negative electrode current collector 32. The thickness of the negative electrode mixture material layers 34 may be adjusted by pressing the negative electrode mixture material layers 34 formed on the two surfaces of the negative electrode current collector 32.

In step S12, the density of each negative electrode mixture material layer 34 is 1.14 grams per cubic centimeter or greater.

Next, sodium is removed from the negative electrode sheet 30 (S14). The negative electrode sheet 30 formed in step S12 is washed with a non-aqueous electrolyte to remove sodium. The non-aqueous electrolyte may be liquid in which supporting salt is dissolved in an organic solvent. The supporting salt is, for example, lithium salt. Step S14 may include immersing the negative electrode sheet 30 in the non-aqueous electrolyte for a predetermined time, washing the surfaces of the negative electrode sheet 30 with, for example, an organic solvent or the like, and drying the negative electrode sheet 30. After the above three steps are sequentially performed, the three steps may be repeated. When the negative electrode thickener contains CMC as thickener, the thickener tends to contain a particularly large amount of sodium. In this case, the sodium in the above step is removed through the following reaction.

CMC-Na+LiOH→CMC-Li+NaOH

Thus, sodium is removed when CMC-Na reacts with LiGH and replaces sodium of CMC-Na with lithium.

In step S14, the sodium concentration of the negative electrode sheet 30 is greater than 532 ppm and less than 71100 ppm. More preferably, the sodium concentration of the negative electrode sheet 30 is 700 ppm or greater.

Next, a stack of the negative electrode sheet 30, the positive electrode sheet 40, and the separators 50 is rolled to form the electrode body 20 (S16). Specifically, the negative electrode sheet 30, the positive electrode sheet 40, and the separators 50 arranged therebetween are stacked, and the stack is rolled in direction L shown in FIG. 2 about a rolling axis.

Next, the electrode body 20 is accommodated in the battery case 12 (S18). In step S18, the positive electrode connection portion 46 is electrically connected to the positive electrode external terminal 16. The negative electrode connection portion 36 is electrically connected to the negative electrode external terminal 18. Then, the lid 19 is laser-welded to the battery case 12 to seal and close the opening of the battery case 12 with the lid 19. At this stage, the non-aqueous electrolyte 14 has not been injected, and the liquid injection hole of the lid 19 is still open.

Next, the non-aqueous electrolyte 14 is injected into the battery case 12 (S20). More specifically, the non-aqueous electrolyte 14 is injected into the battery case 12 accommodating the electrode body 20.

The non-aqueous electrolyte 14 is a composition in which supporting salt is contained in a non-aqueous solvent. The non-aqueous solvent may be one type or two or more types of materials selected from the group including propylene carbonate, ethylene carbonate, diethyl carbonate, dimethyl carbonate, ethyl methyl carbonate, and the like. The supporting salt may be one type or two or more types of lithium compounds (lithium salts). The lithium compounds include LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, the non-aqueous solvent is ethylene carbonate. Lithium bis(oxalato)borate is added as an additive to the non-aqueous electrolyte 14 to serve as lithium salt. In the following, lithium bis(oxalato)borate will be referred to as LiBOB.

The concentration of LiBOB in the non-aqueous electrolyte 14 injected in step S20 is set to 0.35 wt % or greater and 0.56 wt % or less.

The viscosity of the non-aqueous electrolyte 14 injected in step S20 is set to 3.9 [cP] or less. The viscosity is measured with an Ubbelohde viscometer.

Next, charging and discharging of the lithium-ion rechargeable battery 10 are repeated a predetermined number of times (S22). Step S22 forms a solid electrolyte interphase (SEI) coating derived from LiBOB.

### Operation and Advantages of Present Embodiment

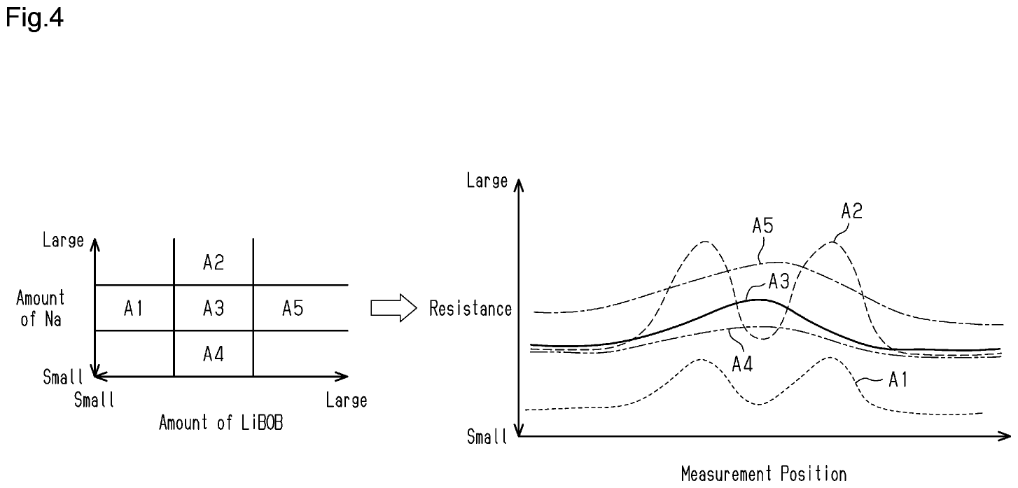

FIG. 4 shows the resistance of the negative electrode sheet 30 in accordance with various sodium concentrations in the negative electrode sheet 30 formed in step S14 and various concentrations of LiBOB in the non-aqueous electrolyte 14 injected in step S20. Specifically, the right side of FIG. 4 shows a graph of curves indicating a resistance distribution of the negative electrode sheet 30 in the direction W of the rolling axis shown in FIG. 2. The curves in the graph at the right side of FIG. 4 respectively correspond to regions A1 to A5 divided in accordance with the sodium concentration and the LiBOB concentration shown in the graph at the left side of FIG. 4. Region A3 is used in the present embodiment.

As shown in FIG. 4, when using region A1, the resistance of the negative electrode sheet 30 had two local maximum values in the direction parallel to the rolling axis. This is because the concentration of LiBOB was excessively low.

The electrode body 20 is formed by rolling the stack of the negative electrode sheet 30, the positive electrode sheet 40, and the separators 50. Thus, when the non-aqueous electrolyte 14 is injected in step S20, the non-aqueous electrolyte 14 enters the negative electrode sheet 30 from the two ends in the direction W parallel to the rolling axis.

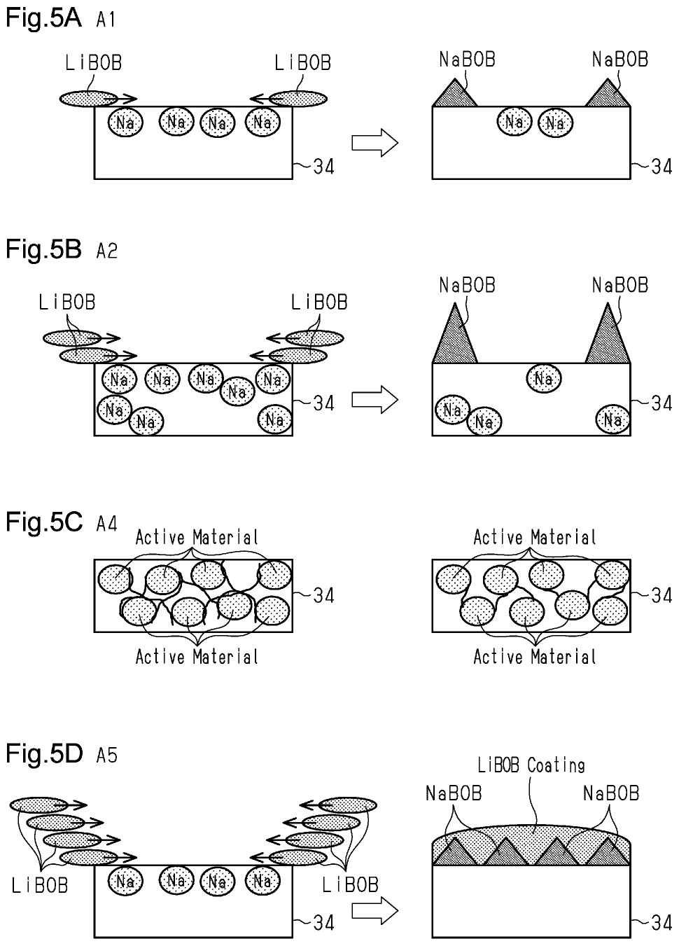

As shown in FIG. 5A, when the concentration of LiBOB is excessively low, most of the LiBOB reacts with sodium at the two ends. Thus, subtle LiBOB permeates into the central portion of the negative electrode sheet 30 in the direction W parallel to the rolling axis. This results in a greatly uneven coating derived from LiBOB being formed on the negative electrode sheet 30. The uneven coating will shorten the life of the negative electrode sheet 30.

Further, as shown in FIG. 4, when using region A2, the resistance of the negative electrode sheet 30 had two local maximum values in the direction parallel to the rolling axis. This is because the concentration of sodium in the negative electrode sheet 30 was excessively high.

As shown in FIG. 5B, when the sodium concentration in the negative electrode sheet 30 is excessively high, most of the LiBOB entering the two ends in the direction W parallel to the rolling axis reacts with sodium at the two ends. Thus, subtle LiBOB permeates into the central portion of the negative electrode sheet 30 in the direction W parallel to the rolling axis. This results in a greatly uneven coating derived from LiBOB being formed on the negative electrode sheet 30. The uneven coating will shorten the life of the negative electrode sheet 30.

Further, as shown in FIG. 4, when using region A4, variation in the resistance of the negative electrode sheet 30 was small. However, in this case, the negative electrode mixture material layer 34 of the negative electrode sheet 30 will have a low delamination resistance.

Specifically, for example, when sodium is removed from CMC-Na as described above, sodium in CMC-Na is replaced by lithium to obtain CMC-Li. Thus, CMC-Li will have a lower molecular weight than CMC-Na.

Thus, as shown in the right side of FIG. 5C, molecular chains are shorter than the molecular chains shown in the left side of FIG. 5C. The shorter molecular chains will hinder cohesion. Thus, the binding force between the negative electrode active materials will decrease and lower the delamination resistance.

Further, as shown in FIG. 4, when using region A5, variation in the resistance of the negative electrode sheet 30 was small but the resistance of the negative electrode sheet 30 was large. This is because the concentration of LiBOB in the non-aqueous electrolyte 14 was excessively high.

Specifically, as shown in FIG. 5D, when the concentration of LiBOB was excessively high, the coating formed by the reaction of LiBOB with sodium was thickly covered by the coating derived from LiBOB that did not react with sodium. The coating had a large resistance. Thus, the resistance of the negative electrode sheet 30 was excessively large.

For the above reasons, region A3 was used in the present embodiment.

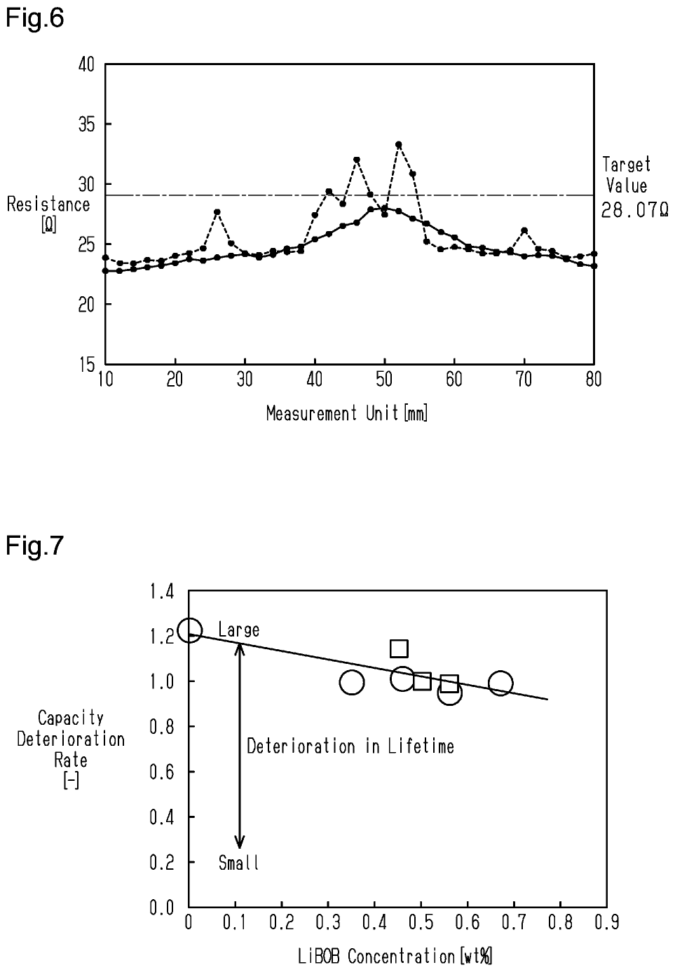

In FIG. 6, the solid line indicates the measurement data about a resistance distribution in the negative electrode sheet 30 of the present embodiment. In FIG. 6, the broken line indicates measurement data about the resistance distribution when region A2 was used. As shown in FIG. 6, in the present embodiment, the resistance of the negative electrode sheet 30 was less than 28.07 ohms in the entire region.

FIG. 7 shows the relationship between the LiBOB concentration in the non-aqueous electrolyte 14 and the capacity deterioration rate of the lithium-ion rechargeable battery 10. The capacity deterioration rate is quantified with an absolute value of the inclination of the standardized capacity of the lithium-ion rechargeable battery 10 relative to the number of days. The standardized capacity is the ratio of the capacity during a storage test to the capacity before storage, which is the initial capacity in the storage test. The number of days is the number of days elapsed from when the storage test starts. A larger absolute value of the inclination of the standardized capacity indicates a larger decrease in lifetime. As shown in FIG. 7, as the LiBOB concentration in the non-aqueous electrolyte 14 increases, the deterioration rate decreases. However, when the LiBOB concentration in the non-aqueous electrolyte 14 increases, the resistance of the negative electrode sheet 30 will increase.

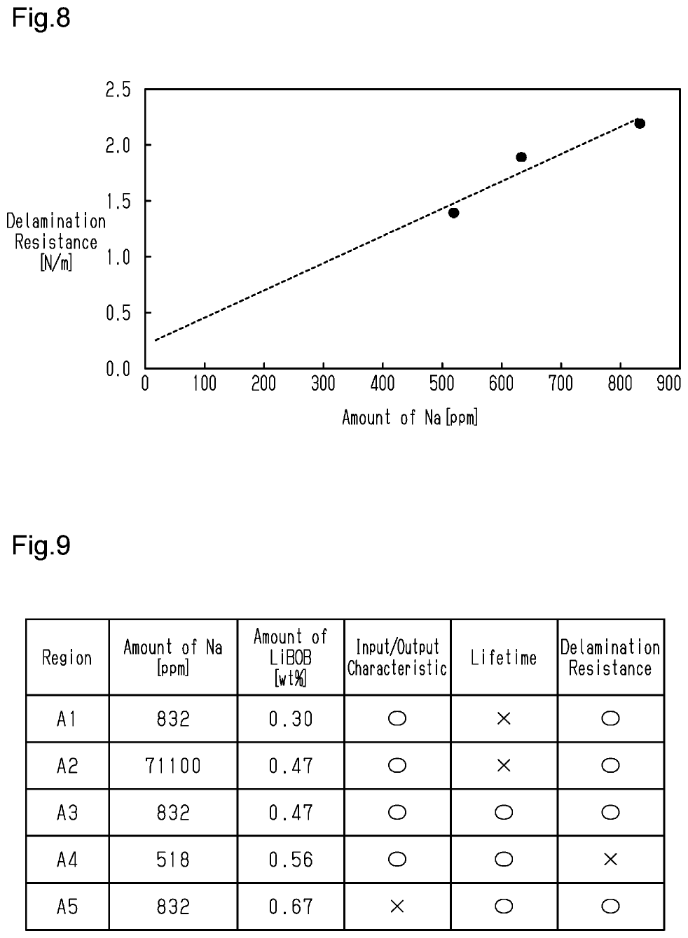

FIG. 8 shows the relationship between the sodium concentration in the negative electrode sheet 30 and the delamination resistance of the negative electrode sheet 30. As shown in FIG. 8, when the sodium concentration decreases, the delamination resistance decreases. However, an increase in the sodium concentration in the negative electrode sheet 30 will increase unevenness in the coating derived from LiBOB in the negative electrode sheet 30.

FIG. 9 shows the evaluation results of characteristics when the sodium concentration in the negative electrode sheet 30 and the concentration of LiBOB in the non-aqueous electrolyte 14 are set in accordance with one of regions A1 to A5. Regions A1 and A2 result in a large unevenness in the coating derived from LiBOB that shortens the lifetime. Region A4 results in a low delamination resistance of the negative electrode sheet 30. Region A5 results in an excessively large resistance of the negative electrode sheet 30 and deteriorates the input/output characteristic.

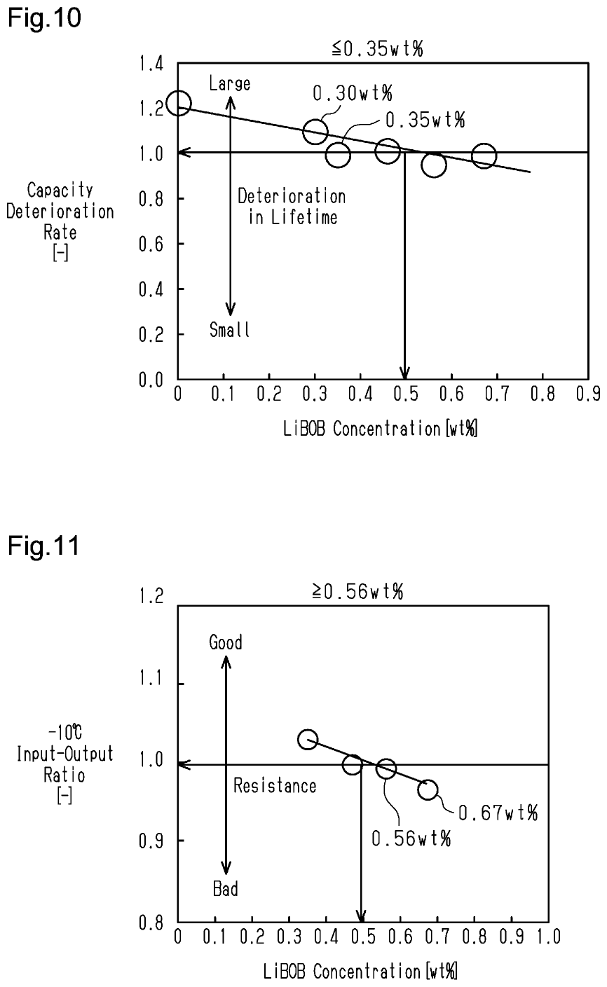

Parameter setting in the present embodiment will now be described with reference to FIGS. 10 to 12.

FIG. 10 shows the relationship between the concentration of LiBOB added to the non-aqueous electrolyte 14 and a capacity deterioration characteristic. In the vertical axis shown in FIG. 10, numerical value 1 is used as a reference indicating the capacity deterioration characteristic when the concentration of LiBOB added to the non-aqueous electrolyte 14 was 0.5 wt %.

As shown in FIG. 10, when the concentration of LiBOB added to the non-aqueous electrolyte 14 was 0.35 wt % or greater, the capacity deterioration rate was substantially constant. In contrast, when the concentration of LiBOB added to the non-aqueous electrolyte 14 was less than 0.35 wt %, the capacity deterioration characteristic decreased. Thus, in the present embodiment, the concentration of LiBOB added to the non-aqueous electrolyte 14 is set to 0.35 wt % or greater.

FIG. 11 shows the relationship between the concentration of LiBOB added to the non-aqueous electrolyte 14 and an input-output ratio, which is the ratio between the input and output of the lithium-ion rechargeable battery 10. Specifically, FIG. 11 shows the relationship when the temperature of the lithium-ion rechargeable battery 10 was −10° C. In the vertical axis shown in FIG. 11, numerical value 1 was used as a reference indicating the input-output ratio when the concentration of LiBOB added to the non-aqueous electrolyte 14 was 0.5 wt %.

As shown in FIG. 11, when the concentration of LiBOB added to the non-aqueous electrolyte 14 was 0.56 wt % or less, the input-output ratio of the negative electrode sheet 30 was equivalent to that when the concentration was 0.5 wt %. In contrast, when the concentration of LiBOB added to the non-aqueous electrolyte 14 exceeded 0.56 wt %, the input-output ratio of the negative electrode sheet 30 deteriorated.

Thus, in the present embodiment, the concentration of LiBOB added to the non-aqueous electrolyte 14 is set to 0.35 w % or greater and 0.56 wt % or less.

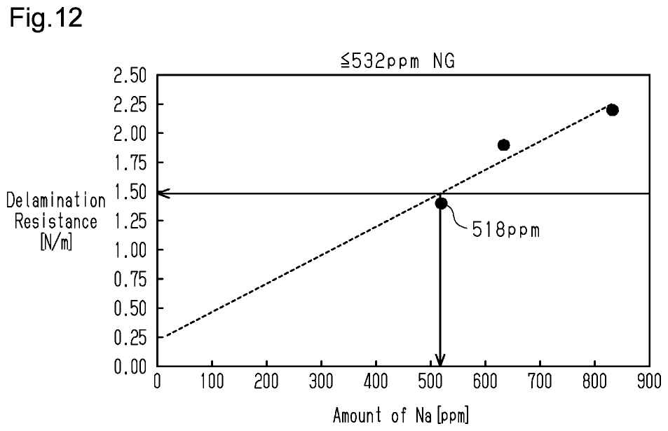

FIG. 12 shows the relationship between the sodium concentration in the negative electrode sheet 30 and the delamination resistance together with the lower limit of a permissible range of the delamination resistance. As shown in FIG. 12, the lower limit of the delamination resistance is set to 1.5 (N/m). In this case, the sodium concentration in the negative electrode sheet 30 needs to be greater than 532 ppm. In order to ensure a sufficient delamination resistance for the negative electrode sheet 30, it is desirable that the sodium concentration in the negative electrode sheet 30 be 700 ppm or greater. The upper limit of the sodium concentration in the negative electrode sheet 30 is determined in accordance with the upper limit value of the resistance of the negative electrode sheet 30 shown in FIG. 6 and the amount of a coating derived from LiBOB formed in the central portion of the negative electrode sheet 30.

As described above, the present embodiment obtains the input/output characteristic and the life of the lithium-ion rechargeable battery 10 and the delamination resistance of the negative electrode sheet 30 at a high level by adjusting the concentration of LiBOB added to the non-aqueous electrolyte 14 and the sodium concentration of the negative electrode sheet 30.

Furthermore, in the present embodiment, the density of the negative electrode mixture material layer 34 is set to 1.14 grams per cubic centimeter or greater. This is because when the density of the negative electrode mixture material layer 34 is low, the rate of the non-aqueous electrolyte 14 permeating the negative electrode sheet 30 will decrease in step S20. When the rate of the non-aqueous electrolyte 14 permeating the negative electrode sheet 30 decreases, the amount of LiBOB reacting with sodium will increase at the two ends in the direction W parallel to the rolling axis, and the amount of LiBOB reaching the central portion in the direction W will have a tendency to decrease.

In this embodiment, the viscosity of the non-aqueous electrolyte 14 is set to 3.9 [cP] or less. This is because when the viscosity is high, the rate of the non-aqueous electrolyte 14 permeating into the negative electrode sheet 30 will decrease in step S20. When the rate of the non-aqueous electrolyte 14 permeating the negative electrode sheet 30 decreases, the amount of LiBOB reacting with sodium will increase at the two ends in the direction W parallel to the rolling axis, and the amount of LiBOB reaching the central portion in the direction W will have a tendency to decrease.

Aspects

Although aspects acknowledged from the above embodiments and combination of aspects are described below, it will be understood that various aspects of elements not limited to such aspects and combinations are described in the present disclosure.

Aspect 1

A non-aqueous electrolyte rechargeable battery, including a positive electrode, a negative electrode, and a non-aqueous electrolyte, where the negative electrode has a sodium concentration of greater than 532 ppm and less than 71100 ppm, the non-aqueous electrolyte rechargeable battery includes a LiBOB equivalent, the LiBOB equivalent is lithium bis(oxalato)borate in the non-aqueous electrolyte or a substance formed when the lithium bis(oxalato)borate reacts with another substance, and the non-aqueous electrolyte has a hypothetical concentration of the LiBOB equivalent of 0.35 wt % or greater and 0.56 wt % or less when an amount of the LiBOB equivalent is converted into a weight of the lithium bis(oxalato)borate.

When the amount of sodium relative to lithium bis(oxalato)borate is excessively large, a greatly uneven coating derived from lithium bis(oxalato)borate will be formed on the negative electrode. In contrast, when the amount of sodium in the negative electrode is excessively small, the delamination resistance of the negative electrode will decrease. Further, when the amount of lithium bis(oxalato)borate is excessively large, the resistance of the negative electrode will become excessively large.

In this respect, with the above configuration, the amount of sodium is set to maintain a high delamination resistance, and the amount of sodium relative to the amount of LiBOB equivalent is set in an appropriate manner. This appropriately forms a coating derived from lithium bis(oxalato)borate without lowering the delamination resistance of the negative electrode.

Aspect 2

The non-aqueous electrolyte rechargeable battery according to aspect 1, where the negative electrode includes a negative electrode current collector and a negative electrode active material layer, and the negative electrode active material layer has a density of 1.14 grams per cubic centimeter or greater.

When the density of the negative electrode is low, reaction between lithium bis(oxalato)borate and sodium will have a tendency to increase unevenness in the coating derived from lithium bis(oxalato)borate. In contrast, the above configuration will ensure the density of the negative electrode and avoid the formation of an uneven coating derived from lithium bis(oxalato)borate.

Aspect 3

The non-aqueous electrolyte rechargeable battery according to aspect 1 or 2, where the non-aqueous electrolyte has a viscosity of 3.9 [cP] or less.

When the viscosity of the non-aqueous electrolyte is high, reaction between lithium bis(oxalato)borate and sodium will have a tendency to increase unevenness in the coating derived from lithium bis(oxalato)borate. In contrast, the above configuration limits the viscosity of the non-aqueous electrolyte at a lower level and avoids the formation of an uneven coating derived from lithium bis(oxalato)borate.

Aspect 4

The non-aqueous electrolyte rechargeable battery according to any one of aspects 1 to 3, where the negative electrode has a sodium concentration of 700 ppm or greater.

The above configuration sufficiently increases the delamination resistance of the negative electrode.

Aspect 5

The non-aqueous electrolyte rechargeable battery according to any one of aspects 1 to 4, where the positive electrode and the negative electrode are rolled with a separator held between the positive electrode and the negative electrode into a rolled electrode body, and the negative electrode in the rolled electrode body has a resistance that increases from an end to a central portion in a direction parallel to a rolling axis.

When the resistance of the negative electrode is maximized at the two sides in the direction parallel to the rolling axis, unevenness in the coating derived from lithium bis(oxalato)borate will have a tendency to increase. In contrast, the above configuration increases the resistance of the negative electrode from the ends toward the central portion in the direction parallel to the rolling axis. Thus, compared to a configuration in which the resistance of the negative electrode is the maximum at the two sides, unevenness in the coating derived from lithium bis(oxalato)borate will be limited.

Aspect 6

A method for manufacturing a non-aqueous electrolyte rechargeable battery including a positive electrode, a negative electrode, and a non-aqueous electrolyte, the method including: obtaining the negative electrode having a sodium concentration that is greater than 532 ppm and less than 71100 ppm; accommodating an electrode body including the positive electrode and the negative electrode in a battery case; and injecting the non-aqueous electrolyte into the battery case, where the injected non-aqueous electrolyte includes a LiBOB equivalent, the LiBOB equivalent is lithium bis(oxalato)borate or a substance formed by a reaction of the lithium bis(oxalato)borate with another substance, and the injected non-aqueous electrolyte has a concentration of the LiBOB equivalent of 0.35 wt % or greater and 0.56 wt % or less when an amount of the LiBOB equivalent is converted into a weight of the lithium bis(oxalato)borate.

In the injecting step, the non-aqueous electrolyte flows from the ends to the central portion of the electrode body. In this case, when the amount of sodium in the negative electrode relative to the amount of lithium bis(oxalato)borate is excessively large, the amount of lithium bis(oxalato)borate reacting with sodium will increase at the end of the electrode body. Thus, a coating derived from lithium bis(oxalato)borate will have a tendency to be located at the end.

In contrast, when the amount of sodium is excessively small, the delamination resistance of the negative electrode will decrease. Further, when the amount of lithium bis(oxalato)borate is excessively large, the amount of the coating derived from lithium bis(oxalato)borate will become excessively large. This will increase the resistance of the negative electrode.

Thus, the above method adjusts the amount of lithium bis(oxalato)borate and the amount of sodium in an appropriate manner. This maintains a high delamination resistance of the negative electrode and appropriately forms the coating derived from lithium bis(oxalato)borate.

Aspect 7

The method according to aspect 6, where the negative electrode includes a negative electrode current collector and a negative electrode active material layer, and the negative electrode active material layer has a density of 1.14 grams per cubic centimeter or greater.

When the density of the negative electrode active material is excessively low, the rate of the non-aqueous electrolyte flowing from the end to the central portion of the negative electrode will decrease in the injecting step. Thus, the amount of lithium bis(oxalato)borate reacting with sodium will increases at the end. This will increase unevenness in the coating derived from lithium bis(oxalato)borate. Thus, the above method adjusts the density of the negative electrode active material so that the density will not become excessively low. This limits unevenness in the coating derived from lithium bis(oxalato)borate.

Aspect 8

The method according to aspect 6 or 7, where the non-aqueous electrolyte has a viscosity of 3.9 [cP] or less.

When the viscosity of the non-aqueous electrolyte is excessively high, the rate of the non-aqueous electrolyte entering the central portion from the end of the negative electrode will decrease in the injecting step. Thus, the amount of lithium bis(oxalato)borate reacting with sodium will increase at the end. This increases unevenness in the coating derived from lithium bis(oxalato)borate. Thus, the above method adjusts the viscosity of the non-aqueous electrolyte so that the viscosity will not become excessively high. This limits unevenness in the coating derived from lithium bis(oxalato)borate.

Aspect 9

The method according to any one of aspects 6 to 8, where the negative electrode has a sodium concentration of 700 ppm or greater.

The above method sufficiently increases the delamination resistance of the negative electrode.

Aspect 10

A non-aqueous electrolyte rechargeable battery including a positive electrode, a negative electrode, and a non-aqueous electrolyte, where
a sodium concentration in the negative electrode is greater than 532 ppm and less than 71100 ppm,
the non-aqueous electrolyte rechargeable battery includes a LiBOB equivalent,
the LiBOB equivalent includes lithium bis(oxalato)borate in the non-aqueous electrolyte and a substance formed by reaction of the lithium bis(oxalato)borate with another substance in the negative electrode, and
the non-aqueous electrolyte has a concentration of the lithium bis(oxalato)borate of 0.35 wt % or greater and 0.56 wt % or less when an amount of the substance from the LiBOB equivalent, formed in the negative electrode, is converted (back-calculated) into the weight of the lithium bis(oxalato)borate and the converted (back-calculated) weight of the lithium bis(oxalato)borate is added to the weight of the lithium bis(oxalato)borate in the non-aqueous electrolyte.

Aspect 11

A method for manufacturing a non-aqueous electrolyte rechargeable battery, the method including:
preparing a negative electrode and a positive electrode, where a sodium concentration in the prepared negative electrode is greater than 532 ppm and less than 71100 ppm;
accommodating an electrode body including the positive electrode and the negative electrode in a battery case; and
injecting a non-aqueous electrolyte containing lithium bis(oxalato)borate (LiBOB) into the battery case, where
the injected non-aqueous electrolyte has a concentration of the LiBOB of 0.35 wt % or greater and 0.56 wt % or less.

Correspondence

The corresponding relationship between the elements in the above embodiments and the elements described in the above aspect is as follows. In aspects 1 and 3 to 5, the LiBOB equivalent corresponds to the substance injected in step S20 and/or a coating or the like formed by reaction of the substance with sodium or the like in step S22. In aspects 2 and 7, the negative electrode active material layer corresponds to the negative electrode mixture material layer 34. In aspects 6, 8, and 9, the obtaining a negative electrode corresponds to steps S12 and S14. The accommodating corresponds to step S18. The injecting corresponds to step S20.

### OTHER EMBODIMENTS

The present embodiment may be modified as follows. The above-described embodiment and the following modifications can be combined as long as the combined modifications remain technically consistent with each other.

Obtaining Negative Electrode

The obtaining a negative electrode does not need to include step S14. In the obtaining a negative electrode, the sodium concentration in the negative electrode may satisfy the above condition without removing Na.

Injecting

The LiBOB equivalent added to the non-aqueous electrolyte in the injecting does not need to be lithium bis(oxalato)borate. For example, a substance reacting with lithium bis(oxalato)borate may be used as LiBOB equivalent if the substance forms a coating equivalent to that of lithium bis(oxalato)borate in step S22.

Electrode Body

The electrode body does not need to be a flattened roll and may be, for example, a cylindrical roll.

The electrode body 20 does not need to be a roll and may a stack of the positive electrode sheet 40, the negative electrode sheet 30, and the separators 50 accommodated in the battery case 12. In this case, for example, when the concentration of sodium is excessively high, a large amount of lithium bis(oxalato)borate will react with sodium at the end of the electrode body during the injection and increase unevenness. Thus, the above condition needs to be satisfied.

Non-Aqueous Electrolyte Rechargeable Battery

The non-aqueous electrolyte rechargeable battery does not need to be a thin and flat battery and may be, for example, a cylindrical battery or the like. The non-aqueous electrolyte rechargeable battery does not need to be an onboard battery and may be a battery for a marine vessel, an aircraft, or a stationary battery.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous electrolyte rechargeable battery, comprising:
a positive electrode;
a negative electrode; and
a non-aqueous electrolyte, wherein
the negative electrode has a sodium concentration of greater than 532 ppm and less than 71100 ppm,
the non-aqueous electrolyte rechargeable battery includes a LiBOB equivalent,
the LiBOB equivalent is lithium bis(oxalato)borate in the non-aqueous electrolyte or a substance formed when the lithium bis(oxalato)borate reacts with another substance, and
the non-aqueous electrolyte has a hypothetical concentration of the LiBOB equivalent of 0.35 wt % or greater and 0.56 wt % or less when an amount of the LiBOB equivalent is converted into a weight of the lithium bis(oxalato)borate.

2. The non-aqueous electrolyte rechargeable battery according to claim 1, wherein
the negative electrode includes a negative electrode current collector and a negative electrode active material layer, and
the negative electrode active material layer has a density of 1.14 grams per cubic centimeter or greater.

3. The non-aqueous electrolyte rechargeable battery according to claim 1, wherein the non-aqueous electrolyte has a viscosity of 3.9 cP or less.

4. The non-aqueous electrolyte rechargeable battery according to claim 1, wherein the negative electrode has a sodium concentration of 700 ppm or greater.

5. The non-aqueous electrolyte rechargeable battery according to claim 1, wherein
the positive electrode and the negative electrode are rolled with a separator held between the positive electrode and the negative electrode into a rolled electrode body, and
the negative electrode in the rolled electrode body has a resistance that increases from an end to a central portion in a direction parallel to a rolling axis.

6. A method for manufacturing a non-aqueous electrolyte rechargeable battery including a positive electrode, a negative electrode, and a non-aqueous electrolyte, the method comprising:
obtaining the negative electrode having a sodium concentration that is greater than 532 ppm and less than 71100 ppm;
accommodating an electrode body including the positive electrode and the negative electrode in a battery case; and
injecting the non-aqueous electrolyte into the battery case, wherein
the injected non-aqueous electrolyte includes a LiBOB equivalent,
the LiBOB equivalent is lithium bis(oxalato)borate or a substance formed by a reaction of the lithium bis(oxalato)borate with another substance, and
the injected non-aqueous electrolyte has a concentration of the LiBOB equivalent of 0.35 wt % or greater and 0.56 wt % or less when an amount of the LiBOB equivalent is converted into a weight of the lithium bis(oxalato)borate.

7. The method according to claim 6, wherein
the negative electrode includes a negative electrode current collector and a negative electrode active material layer, and
the negative electrode active material layer has a density of 1.14 grams per cubic centimeter or greater.

8. The method according to claim 6, wherein the non-aqueous electrolyte has a viscosity of 3.9 cP or less.

9. The method according to claim 6, wherein the negative electrode has a sodium concentration of 700 ppm or greater.
